(19) United States
(12) Patent Application Publication
(10) Pub. No.: US 2004/0181516 A1
(43) Pub. Date: Sep. 16, 2004

(54) Methods and systems for monitoring document-production processes

(75) Inventors: Michelle Marie Ellwanger, Omaha, NE (US); David Scott Horton, Omaha, NE (US); Robert Alan Stier, Papillion, NE (US); Glen David Wordekemper, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/389,275

(22) Filed: Mar. 13, 2003

(51) Int. Cl. G06F 7/00

(52) U.S. Cl. 707/3

(57) ABSTRACT

Methods and systems are provide monitoring information for a document-production process. A query requesting status information for production of an identified document is received with a production-monitoring computer. A queriable data store includes status data received periodically for multiple documents that includes the identified document from distinct sources. Each of the distinct sources is configured to provide information related to a subprocess of the document-production process. Status data are retrieved from the queriable data store in accordance with the query with the production-monitoring computer. The retrieved status data are transmitted from the production-monitoring computer as a response to the query.

### BACKGROUND OF THE INVENTION

This application relates generally to document-production processes. More specifically, this application relates to methods and systems for monitoring document-production processes.

Companies whose business involves the production of a large number of documents to be mailed to its customers often contract for the production of those documents to be handled by an outside source. Typically, the outside source has equipment and processes that are designed to produce large numbers of documents efficiently and to distribute those documents to the customers as specified. For example, a financial institution might have many thousands of customers who hold a variety of different types of accounts with the institution, such as savings accounts, checking accounts, credit-card accounts, and the like. In order to handle its monthly reporting to each of its customers regarding the status of and activity on each of the various accounts, the financial institution may provide the customer and account information to the entity that produces the reporting documents and distributes them to the customers. Often, such an entity handles the document production and distribution for multiple financial or other institutions.

Examples of other types of institutions that make use of such entities include health-care institutions, such as health-care providers and insurers. The patients of such institutions often receive information that may be produced and distributed on behalf of the institutions by another entity.

The customers are often unaware of how the production and distribution processes are carried out, and usually unconcerned with it as long as the information they expect is received correctly and on time. In the event that there are complaints from customers, they are directed to the institution that is ultimately responsible for the information, and not to the entity that has been contracted to handle the production and distribution. Responding to such complaints may be difficult because the financial or other institution does not have ready access to what is occurring during the document production processes.

This is merely a simple example of a larger problem faced by organizations that contract to have document production handled by a third party. The lack of direct availability of information regarding the status of document production makes it difficult to monitor how the document-production processes are integrated efficiently into other operations of the organization and to understand their impact on overall operations. There is, accordingly, a general need in the art for methods and systems that permit such organizations easily to monitor document production processes.

### BRIEF SUMMARY OF THE INVENTION

Embodiments of the invention thus provide methods and systems that provide monitoring information for a document-production process. Information regarding the process is collected periodically and stored in a queriable data store that permits queries to be submitted and for corresponding monitoring information to be retrieved from the data store as desired. The scope of the information may be broad, summarizing the status of multiple documents comprehensively, or may be narrow, providing detailed status information of even a single document.

In a first set of embodiments, a method is provided for providing monitoring information for a document-production process. A query requesting status information for production of an identified document is received with a production-monitoring computer. A queriable data store includes status data received periodically for a plurality of documents that includes the identified document from each of a plurality of distinct sources. Each of the distinct sources is configured to provide information related to a subprocess of the document-production process. Status data are retrieved from the queriable data store in accordance with the query with the production-monitoring computer. The retrieved status data are transmitted from the production-monitoring computer as a response to the query.

The identified document may comprise, for example, a paper document or a plastic document. In some embodiments, the query may be received from a client computer on behalf of a client managing a plurality of accounts associated with the plurality of documents. In such embodiments, the identified document may be, for example, an account statement for one of the plurality of accounts or a card that identifies one of the plurality of accounts. In other embodiments, the query may be received from a customer computer on behalf of a customer to whom the document is to be delivered. The status data may comprise image information, permitting the retrieved status data that are transmitted to comprise an image of the identified document.

In another set of embodiments, a method is also provided for providing monitoring information for a document-production process. Status data are periodically retrieved for a plurality of documents from each of a plurality of distinct sources with a data-collection computer. Each of the sources is configured to provide information related to a subprocess of the document-production process. At least a portion of the received status data is stored in a queriable data store with the data collection computer. A query requesting status information for at least one of the plurality of documents is received with a production-monitoring computer. Status data are retrieved from the queriable data store in accordance with the query with the production-monitoring computer. The retrieved status data are transmitted from the production-monitoring computer as a response to the query.

At least some of the plurality of documents may comprise paper documents or may comprise plastic documents. For example, in an embodiment where the query is received from a client computer on behalf of a client managing a plurality of accounts associated with the plurality of documents, the documents may comprise account statements for the accounts or may comprise cards that identify the accounts. The query may alternatively be received from a customer computer on behalf of a customer to whom the document is to be delivered. In some embodiments, at least one of the plurality of distinct sources may comprise an information source interfaced with an external document-delivery tracking facility. In other embodiments, at least one of the plurality of distinct sources may identify supplementary documents collated with each of the plurality of documents. In further embodiments, the status data may comprise image data, in which case transmitting the retrieved status data may comprise transmitting document images from the production-monitoring computer.

The methods of the present invention may be embodied in computer-readable storage media having a computer-readable programs embodied therein for directing operation of the production-monitoring and/or data-collection computers. Such computers may each include a communications system, a processor, and an interface with the queriable data store. The computer-readable programs include instructions for operating the respective computers to monitor document-production processes in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of an architecture that may be used to provide monitoring of document production in an embodiment;

FIG. 2 is a schematic illustration of a computer system on which methods of the invention may be embodied;

FIG. 3 is a flow diagram summarizing methods in various embodiments of the invention; and

FIGS. 4A-4I present exemplary screen shots that may be presented to a user in accordance with embodiments of the invention.

### DETAILED DESCRIPTION OF THE INVENTION

Embodiments of the invention provide methods and systems for monitoring document production processes. In some such embodiments, the document production processes are executed by an entity on behalf of one or more client organizations. The description below sometimes provides illustrations that use an example where a client organization is a financial institution, but there is no such requirement for the invention and the methods are intended also to be applicable to other types of organizations that make use of document production processes. For example, embodiments of the invention may also be used for monitoring the production of health-care documents, a capability that may be useful for compliance with disclosure requirments of the Health Insurance Portability and Accountability Act (“HIPAA”) of 1996.

As used herein, the term “document” is intended to be construed broadly as referring to any item that comprises textual information. The textual information may be alphabetic or numerical, and may be printed, imprinted, embossed, or otherwise marked or encoded on the item. In many embodiments, the document comprises a paper document, such as a printed statement, a letter, a delinquency notice, and the like. In other embodiments, the document is made of a different type of material, such as plastic. Examples of plastic documents thus include credit cards, debit cards, stored-value cards, loyalty-program cards, health-insurance identification cards, and the like. In a specific class of embodiments, the documents comprise “presentation instruments” in which the textual information may be encoded electronically. After production, such presentation instruments may conveniently be incorporated as components of cellular telephones, electronic key fobs, personal digital assistants, rf devices, and the like, and configured individually to identify owners of such devices.

The description herein sometimes refers to “clients” and to “customers.” Reference to “clients” is intended to refer to persons, i.e. individuals, entities, or their agents, on whose behalf documents are produced. Reference to “customers” is intended to refer to persons, i.e. individuals, entities, or their agents, who are to receive the produced documents. Thus, merely for purposes of illustration, in the case where the document comprises a credit-card statement for a credit card issued to Mr. Jones by Bank A, Bank A corresponds to a client and Mr. Jones corresponds to a customer. In other instances, a given person may correspond to both a client and to a customer in different contexts. For example, Franchisee B may use the document-production services for providing documents to its customers, thereby acting as a client, and may at the same time be a recipient of documents produced on behalf of Franchisor C, thereby acting as a customer.

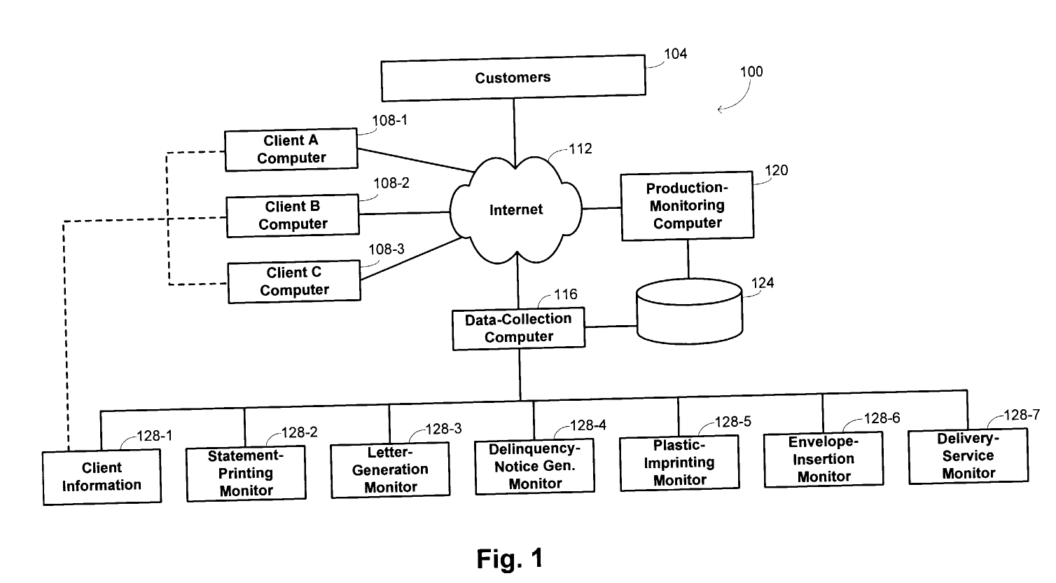

FIG. 1 provides an general overview of an architecture 100 that may be used for implementing embodiments of the invention. In this illustrated embodiment, access to production-process information is provided with an Internet interface, although it will be evident that other networking interfaces may alternatively be used, including dedicated networks, which trade off the advantage of providing greater security against a loss of convenience. In embodiments that do use an Internet or other publicly accessible interface, security may be provided by applying a suitable encryption protocol to transmitted information. The illustrated embodiment is applicable, for example, to a circumstance in which an entity performs document production processes on behalf of each of a plurality of clients, and the clients are provided with a mechanism for monitoring those document-production processes.

Monitoring information may be retrieved as desired by the clients through use of client computers 108 that are connected with the Internet 112. The Internet 112 is also connected with a production-monitoring computer 120 and a data-collection computer 116, each of which is interfaced with a queriable data store 124. In some embodiments, both the production-monitoring computer 120 and the data-collection computer 116 may be controlled by a single entity, although this is not required and they may alternatively be controlled by separate entities. Monitoring information is retrieved from the queriable data store 124 with queries generated by the production-monitoring computer 120 in response to requests from a client computer 108. The information in the queriable data store 124 is provided and maintained by the data-collection computer 116, which is interfaced with a number of distinct monitoring applications 128. The monitoring applications 128 are used to provide specific production-process information to the data-collection computer 116 for organization and storage on the data store 124. In such embodiments, the queriable data store 124 thus includes data collected from a plurality of distinct sources and may be considered to define a queriable database that may be maintained and administered as described in copending, commonly assigned U.S. patent application Ser. No. 10/193,722, entitled “METHODS AND SYSTEMS FOR ORGANIZING INFORMATION FROM MULTIPLE SOURCES,” filed Jul. 10, 2002 by Brian Friedman, the entire disclosure of which is herein incorporated by reference for all purposes.

Examples of sources of information that may be used by the data-collection computer 116 to populate the queriable data store 124 include: a client-information source 128-1; a statement-printing monitor 128-2; a letter-generation monitor 128-3; a delinquency-notice generation monitor 128-4; a plastic-imprinting monitor 128-5; an envelope-insertion monitor 128-6; a delivery-service monitor 128-7; and the like. The information sources 128 may comprise servers that are configured to collect the information for relay to the data-collection computer 116 for processing into a format suitable for the queriable data store 124. The different information sources may be provided at geographically separated locations and may be configured to interface with machinery that performs certain functions. For example, the information may be collected from an interface with a printer, a paper folder, an envelope inserter, and the like.

The client-information source 128-1 may provide information to the data-collection computer regarding the requirements of each of the clients, including such information as the identities and addresses of customers to whom documents are to be provided, the parameters that define when and how the documents are to be distributed, and the content of the documents. Information regarding the content of documents may vary among different types of clients, but in each case specifies the actual textual information to be included in the documents. For example, in the case where the client is a financial institution, the document-content information may include a list of account numbers, transaction records for each of the accounts, balance information, and the like. The client information may be collected from the client computers 108 through the Internet in one embodiment, although it may be more convenient to use other communication mechanisms to collect client information, as indicated with the dashed lines.

A variety of the information sources may comprise monitors that track the status of specific subprocesses. For example, the statement-printing monitor 128-2 may provide information regarding the status of statements that are printed. This is accomplished in one embodiment with an interface between a server that corresponds to the statement-printing monitor 128-2 and one or more printer assemblies that carry out the printing. Similarly, the letter-generation monitor 128-3 may provide information regarding the status of letters that are generated as part of the production process. This may also be accomplished in an embodiment with an interface between a server that corresponds to the letter-generation monitor 128-3 and one or more printing assemblies that carry out the generation of letters as part of the production process. The delinquency-notice generation monitor 128-4 is a further example of an information source that may be configured as a server interfaced with one or more printing assemblies; in this instance, the printing assemblies carry out generation of delinquency notices and the delinquency-notice generation monitor 128-4 provides information on the status of such generation to the data-collection computer 116. In some embodiments, the information provided by one of the paper-production monitors 128-2-128-4 to the data-collection computer 116 may include an image of the document, which may therefore form part of the information maintained in the queriable data store 124.

Similar monitoring may be done for generation of documents that may be made of other materials as well. For example, the plastic-imprinting monitor 128-5 may be configured to provide information to the data-collection computer 116 regarding the status of imprinting plastic documents such as credit cards, debit cards, stored-value cards, and the like. Similar to the different types of paper-production monitors 128-2-128-4, the plastic-imprinting monitor may comprise a server interfaced with an imprinting facility. In addition, in some embodiments, the information provided by the plastic-imprinting monitor 128-5 to the data-collection computer 116 may include an image of the completed plastic document so that such an image may be maintained in the queriable data store 124 for later retrieval.

The envelope-insertion monitor 128-6 may be used to monitor processing functions as the documents are being assembled for distribution to customers. For example, the envelope-insertion monitor 128-6 may comprise an interface to a device configured to collate the documents with promotional inserts or other materials in preparation for distribution. Such a device may also be configured to perform such functions as inserting the collated package into an envelope for mailing, sealing the envelope, and imprinting the address, postage, etc. The device may form part of an assembly of devices that perform such other functions as folding the documents or otherwise preparing them for collation with other materials. In one embodiment, the device is equipped with the capacity to perform individualized assembly functions on a document-by-document basis, such as described in copending, commonly assigned U.S. patent application Ser. No. 10/028,449, entitled “REAL-TIME INTELLIGENT PACKET-COLLATION SYSTEMS AND METHODS,” filed Dec. 19, 2001 by Scott J. Smith et al., the entire disclosure of which is incorporated herein by reference for all purposes.

The delivery-service monitor 128-7 is an example of an information source that is configured to interface with an external tracking facility, such as a mail-tracking facility provided by a postal service or other delivery tracking service provided by a courier. The delivery-service monitor 128-7 may interact with the tracking service by providing known identification information and receiving back tracking information identifying the current location of an individual item.

The combination of the various information sources, as well as some additional information sources in some embodiments, permits a complete picture of document status to be maintained by the data-collection computer 116 on the data store 124. For instance, consider the production of a document that corresponds to paper statement for a financial account. When the information defining the content of the statement has been received by the client-information source 128-1, the fact of that receipt is updated in the data store 124. The status may remain unchanged until a production run that includes that statement is begun. When the statement is printed, that fact is noted by the statement-printing monitor 128-2 so that the data store is provided with updated status information. This status may be maintained until the statement is collated with other materials and prepared for distribution, as noted by the envelope-insertion monitor 128-6. After the statement is released to a delivery service, its status as it is conveyed by the delivery service to its ultimate destination is noted by the delivery-service monitor 128-7 and maintained in the queriable data store 124 by the data-collection computer 116.

Thus, at any time, the client on whose behalf the statement is being produced may retrieve information regarding the production processes. This is done in an embodiment through access over the Internet 112 to a production-monitoring computer 120 that is equipped with tools for submitting queries to the queriable data store 124. The nature of such querying tools is illustrated below with some specific examples. In some instances, the client may access production information to ensure that the production processes are being carried out in accordance with its requirements. Because access to the information in the data store 124 through the production-monitoring computer 120 is not restricted in time, the client is not only able to access it for information during the production of specific documents, but may access it also at other times. For example, the client may access information well after the document has been delivered to a customer and thereby have complete information regarding exactly when the document was produced and where and when it was delivered. When the data store 124 is provided with image information for the document, such later retrieval may include an exact copy of the statement as it was produced and delivered. This information may be used, for example, by the client in responding to complaints by the customer that the document was never received or in disputes regarding the content of what was received. As a further illustration, the information retrieved from the data store 124 by the client may be used in marketing efforts. For example, the client could access the data store 124 through the production-monitoring computer 120 to identify when a plastic document, such as a credit card, is delivered to a specific customer. Such delivery could then be followed up with a telephone call to the customer to confirm receipt of the card and make promotional offers for quick use of the card. These examples are provided merely by way of illustration of the different types of use that exist for information retrieved from the data store 124. There are a large variety of other uses for the information, which will be evident to those of skill in the art after reading this description.

In some embodiments, individual customers 104 may also be provided with access to some of the information from the queriable data store 124 with a connection to the production-monitoring computer 120 through the Internet 104. Usually, information for specific clients is provided to customers 104 only in accordance with the policies of those clients, and is usually not as detailed as the information that may be retrieved by the client computers 108. Availability of even more limited information to customers is useful, however, in providing access to electronic copies of documents to customers, permitting customers to monitor delivery of documents, and the like. The differences in information availability to clients and to customers may be controlled through secure access codes provided to clients that are not available to customers 104.

The examples of different monitoring applications 128 shown in FIG. 1 are not intended to be exhaustive. Additional monitoring applications 128 may be included in certain embodiments, including, for example, applications intended to monitor peripheral aspects of the production process, such as inventory data and/or other types of data.

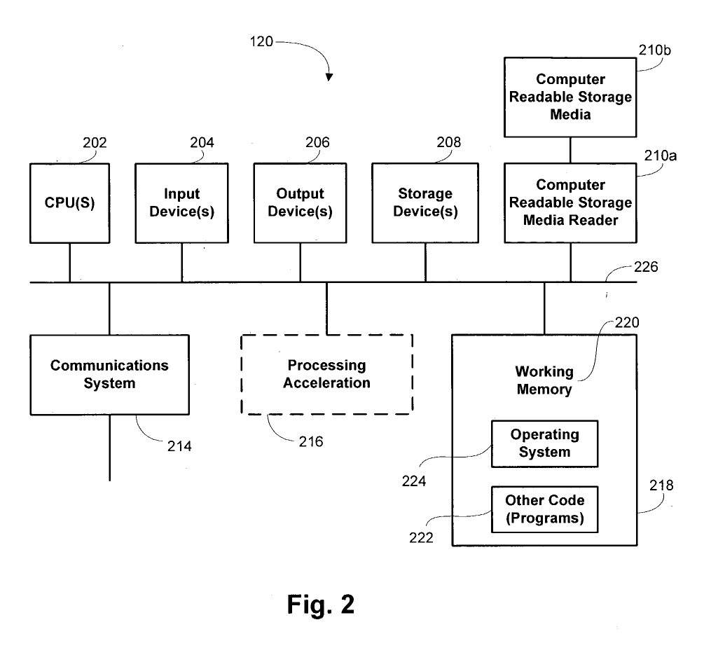

FIG. 2 provides a schematic illustration of a structure of the production-monitoring computer 120 that may be used to implement embodiments of the invention. A similar structure may be used for the data-collection computer 116 in some embodiments, and as well as for individual monitoring applications 128. FIG. 2 broadly illustrates how individual system elements may be implemented in a separated or more integrated manner. The computer 120 is shown comprised of hardware elements that are electrically coupled via bus 226, including a processor 202, an input device 204, an output device 206, a storage device 208, a computer-readable storage media reader 210a, a communications system 214, a processing acceleration unit 216 such as a DSP or special-purpose processor, and a memory 218. The storage device 208 may, in some instances, correspond to the queriable data store 124, but more usually corresponds to a storage device local to the computer 120 and separate from the queriable data store 124. The computer-readable storage media reader 210a is further connected to a computer-readable storage medium 210b, the combination comprehensively representing remote, local, fixed, and/or removable storage devices plus storage media for temporarily and/or more permanently containing computer-readable information. The communications system 214 may comprise a wired, wireless, modem, and/or other type of interfacing connection and permits data to be exchanged with the Internet 112 and/or data store 124 to implement embodiments as described herein.

The computer 120 also comprises software elements, shown as being currently located within working memory 220, including an operating system 224 and other code 222, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

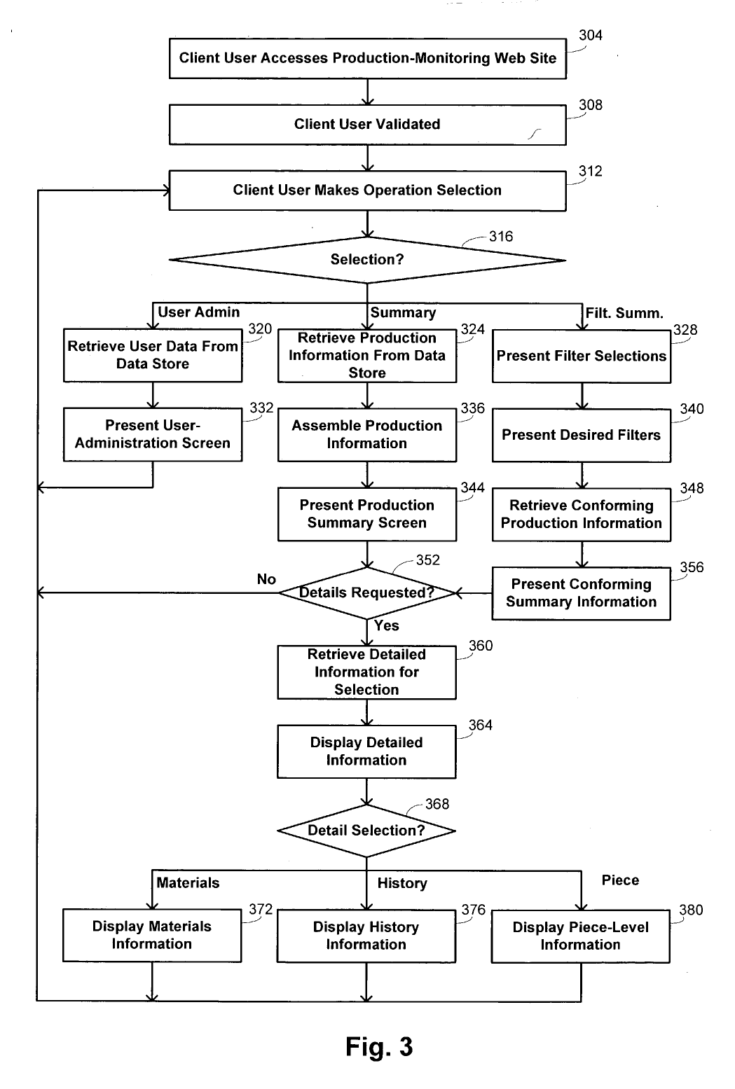

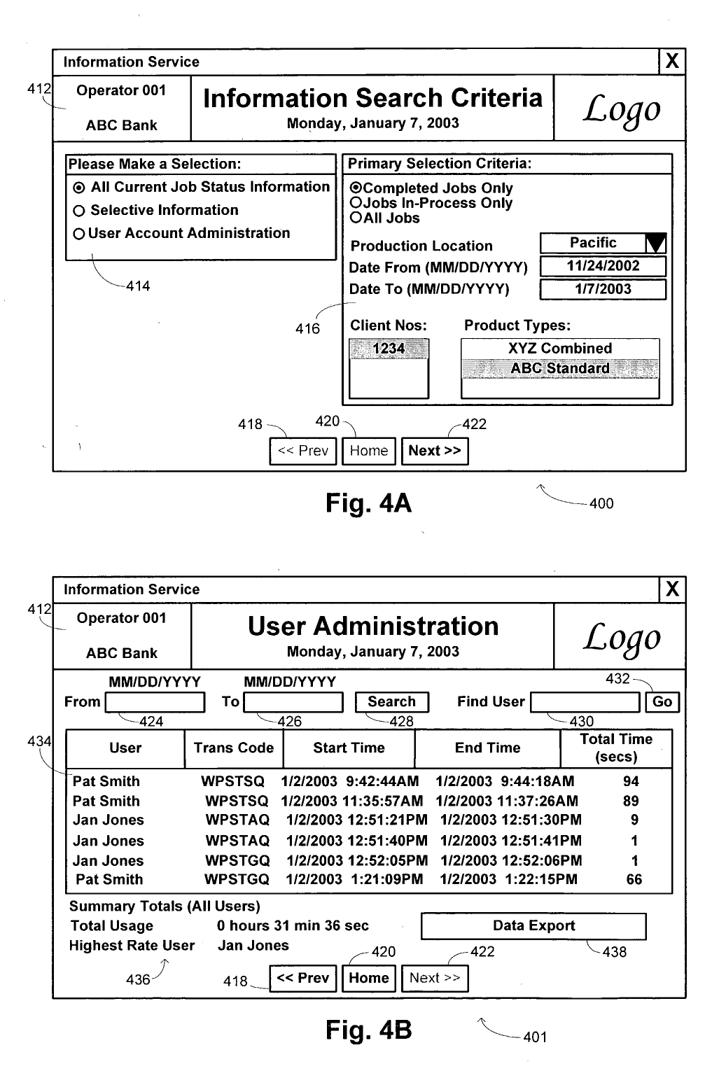

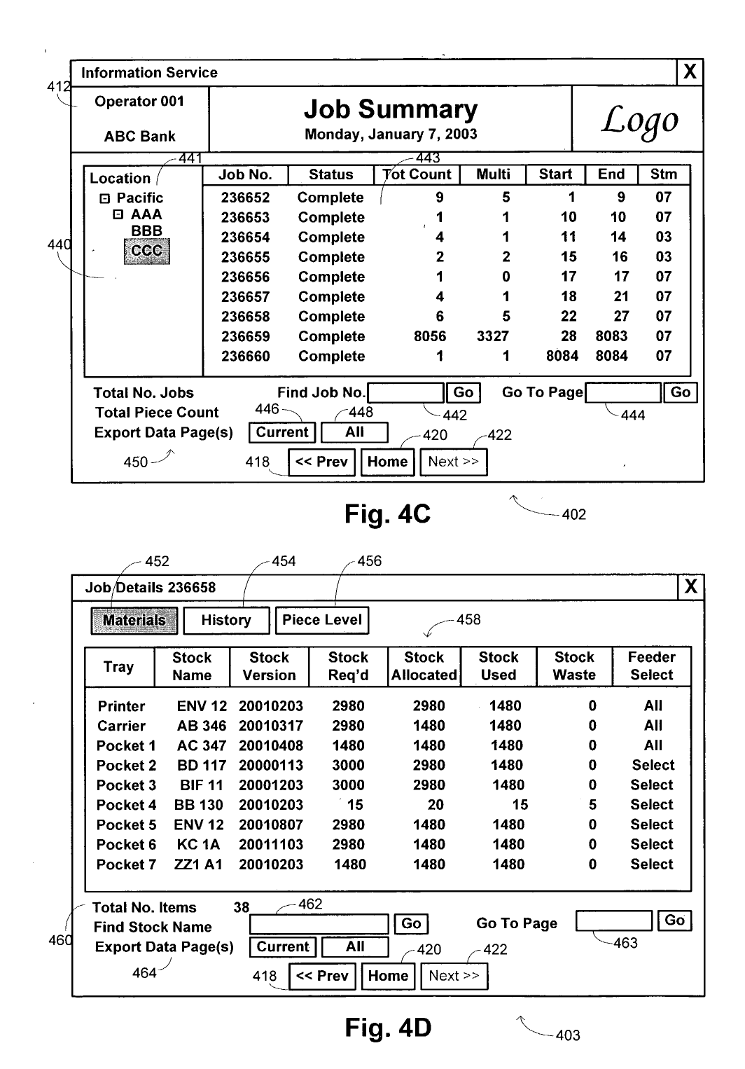

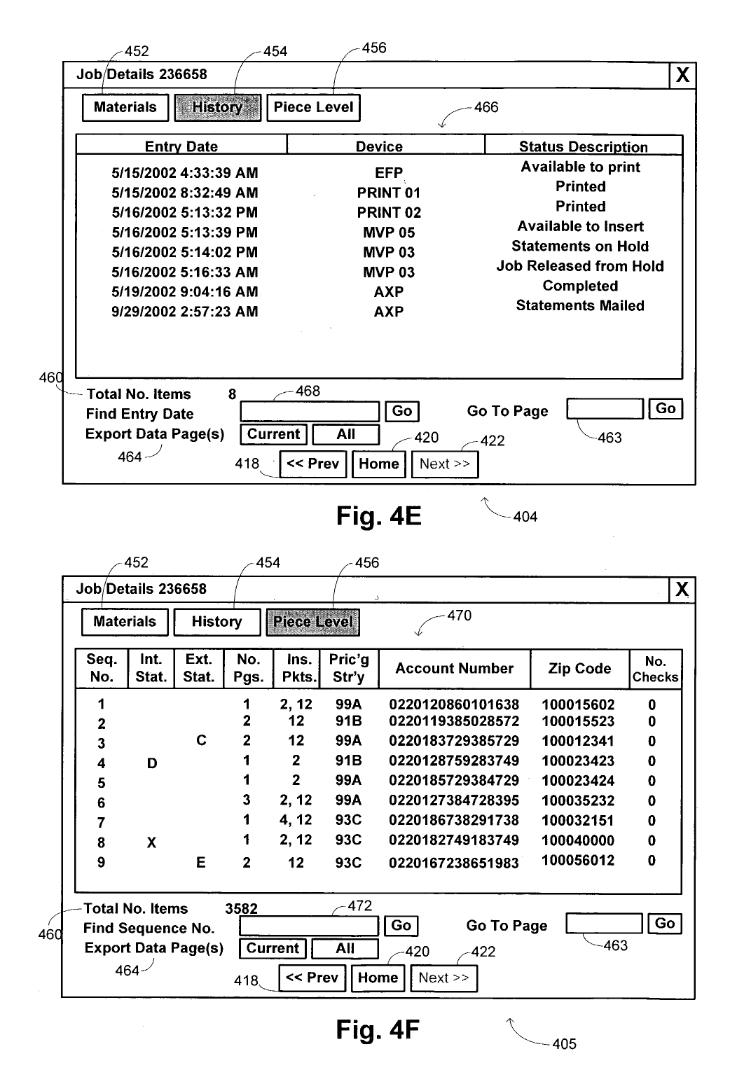

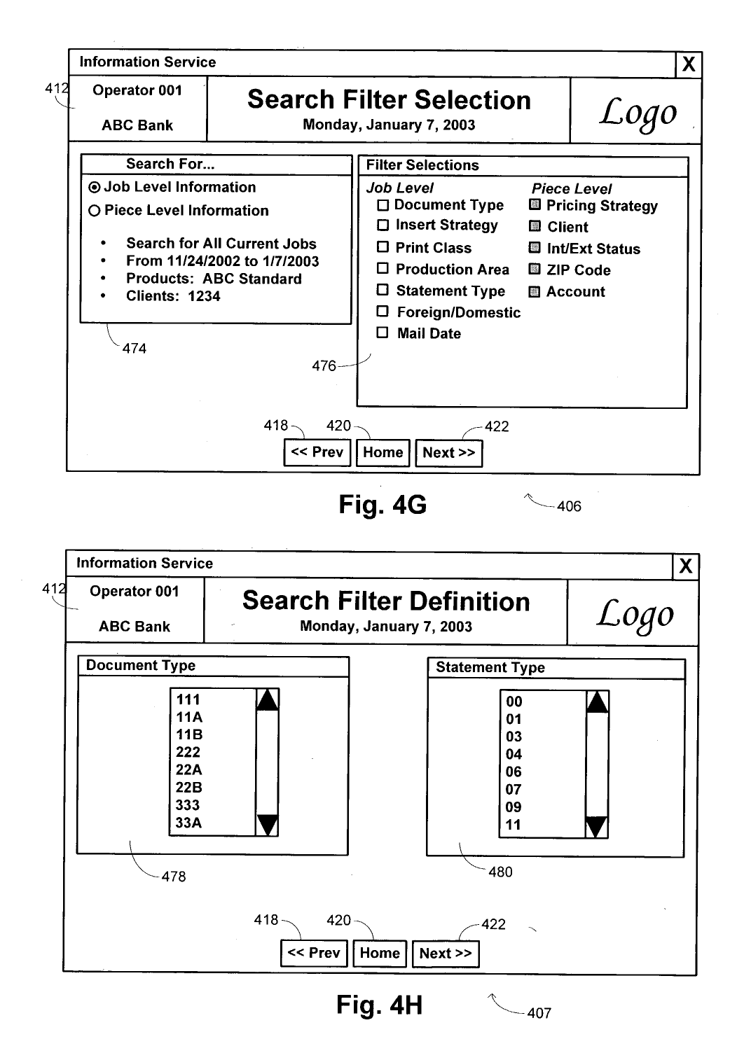

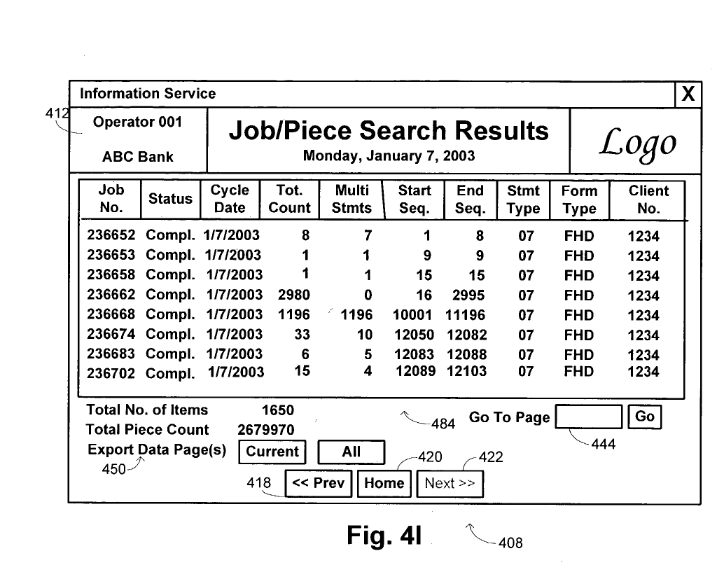

Use of the infrastructure shown in FIG. 1 is illustrated for a number of embodiments with FIGS. 3 and 4A-4I. FIG. 3 provides a flow diagram that summarizes several embodiments, and FIGS. 4A-4I provide examples of screen shots that may be presented to a user of one of the client computers 108 when production processes are being monitored through connection with the production-monitoring computer 120. The following description makes simultaneous reference to FIG. 3 and FIGS. 4A-4I to illustrate the types of information that may be provided to such a user at different points in the flow diagram of FIG. 3.

The methods illustrated with FIG. 3 may begin at block 304, with a client user accessing a web site over the Internet 112 that provides access to the production-monitoring computer. Usually some form of validation is performed of the client user, such as by verifying a password presented by the client user at block 308. The validated client user may be presented with a home screen 400 that provides summary information and primary selection criteria that permit parameters to be defined for the monitoring information that is to be retrieved. The summary information 412 may include, for example, an identification of the validated user, an identification of the client, a heading, the date, and a logo, or any other suitable summary information. A selection field 414 permits the user to make an operation selection to define the type of operation to be performed. In the illustrated example, restriction to one of the available selections is provided by the use of radio buttons, with the available selections corresponding to a summary of production information (“All Current Job Status Information”), a filtered summary of production information (“Selective Information”), and a user-administration functions (“User Account Administration”).

A primary-selection-criteria field 416 permits the user to define parameters to limit the amount of information retrieved. Examples of such parameter definitions include a set of radio buttons that allow the user to specify whether information should be presented only for completed jobs (“Completed Jobs Only”), for jobs still undergoing processing (“Jobs In-Process Only”), or to have no such limitations (“All Jobs”). A field may be provided to specify a production location for the documents, such as by using a drop-down menu to permit selection from a list of possible production locations; in the example in FIG. 4A, the “Pacific” production location has been identified. Fields may be provided to limit the date of production, with both beginning and/or ending dates. A client number may be selected from a list of client numbers by using a cursor control such as a mouse or trackball to highlight the selected client number. In addition, each client number may have multiple product types associated with it. For example, the different product types may correspond to different types of documents, such as a financial-account statement and a debit card. In other instances, the different product types may correspond to different kinds of the same type of document, such as where different customers are to receive statements having different formatting. In the illustration, the desired product type may be selected by highlighting it with suitable cursor controls. In some embodiments, only a portion of the primary selection criteria may be applicable to certain opeartion selections identified in field 414. For example, in one embodiment, the data range may be used for the “User Account Administration” selection, but the other primary selection criteria identified in field 416 might not be used.

The bottom of the home screen 400, and the other screens described below, may include navigation buttons 418, 420, and 422 to move back and forth between screens. In different circumstances, the navigation buttons may be highlighted or grayed out to reflect the existence of screens that can be reached. Activation of the “Home” navigation button 420 on any of the screens will bring up the home screen 400 shown in FIG. 4A.

After being presented with the home screen, the client user may make an operation selection at block 312 of FIG. 3. Different processes may be implemented depending on the operation selection of the client user as determined at block 316. In FIG. 3, the leftmost column corresponds to functions implemented if the user-administration option is selected, the center column corresponds to functions implemented if the option for summary information is selected, and the rightmost column corresponds to functions implemented if the option for filtered summary information is selected.

If the user-administration option is selected, user data are retrieved from the data store 124 at block 320. These user data are used to populate a user-administration screen 401 at block 332, as shown for an exemplary embodiment in FIG. 4B. The information presented on the user-administration screen 401 permits the client to monitor activity of various client users.

The user-administration scheme may include a variety of different search fields to facilitate retrieval of information specifically relevant to the client user. For example, date fields 424 and 426 may be included in combination with a search-activation button 428 to specify a date range over which production processes were executed. Alternatively, a user field 430 may be included in combination with a search-activation button 432 to specify specific individuals who executed production functions. Data that meet the specified criteria are populated in an administration-details field 434, which may include specific information for review by the client user. Each of the detailed entries in the administration-details field 434 includes information regarding each user action that meets the specified criteria. Merely for purposes of illustration, the example shown in FIG. 4B identifies the individual who performed the user action (“User”), identifies the type of user action with a transaction code (“Trans Code”), identifies the start and ending times of the user action, and identifies the total elapsed time to perform the user action. In one embodiment, the types of user actions defined by the transaction codes correspond to the different operation selections that may be selected in field 414 of FIG. 4A, e.g. “WPSTAQ” could correspond to performing a user-administration transaction, “WPSTGQ” could correspond to performing a summary-information transaction, and “WPSTSQ” could correspond to performing a filtered-summary-information transaction. In other embodiments, information regarding other types of user actions may be presented.

The user-administration screen 401 may also include an area 436 to provide summary information, such as the total time usage and to identify the user with the greatest usage time. In some embodiments, a data-export facility 438 may be included to export the usage information collected for the user-administration screen 401 to another application.

If the client user instead selects the summary operation at block 312 of FIG. 3, production information that meets the primary selection criteria specified by the client user in field 416 is retrieved from the data store 124 at block 324. This information is assembled at block 336 for presentation at block 344 on a production summary screen 402, an example of which is illustrated in FIG. 4C. The production summary screen 402 includes a production-details field 440 that provides specific information regarding production processes for review by the client user. The production details field 440 may include a folder list 441 that provides a hierarchical arrangement of information in folders organized according to such criteria as location, product type, date, and the like. Information corresponding to the highlighted folder is presented in the information panel 443, which specifies the production details.

A number of specific types of details are provided herein merely by way of example. The actual production details may more generally depend on specific applications and be tailored to represent document-production aspects of those applications. The production details may include a job number, which corresponds to a system-assigned identifier of a group of documents. In addition, a status indicator may be included for each of the jobs, indicating a current status of the group of documents. Examples of statuses that may be identified in an exemplary embodiment include that the group of documents is ready for printing, is undergoing printing, is completed printing, is undergoing quality inspection, is completed quality inspection, is ready for envelope insertion, is undergoing envelope insertion, is completed envelope insertion, is on hold, has been released to a distribution service, and the like. A total-count indicator may identify the total number of documents in the job. A multipage indicator may identify the number of documents that require more than a single page. Start- and end-sequence indicators may provide system-assigned identifiers of the first and last sequential documents in the job. A statement-type indicator may provide an identification of the type of documents in the job. A client-number indicator may identify the client on whose behalf the job is performed. An insert-strategy indicator may identify the basis on which supplementary material is to be collated with documents. A distribution-date indicator may identify the date on which the documents in the job were released to a distribution facility. In different embodiments, different status indicators may be used in addition to or instead of these, or a subset of the status indicators may be used, depending on the specific nature of the application.

The production summary screen 402 may also include search fields, such as a field 442 to search for a specific job number, a field 444 to go to a specific page of a lengthy information panel 443, and the like. In addition, the production summary screen 402 may include an area 450 to provide summary information, such as the total number of jobs described in the information panel, the total number of independent documents described in the information panel 443, and the like. A data-export facility may also be included, with the ability to export the information currently 446 described in the information panel 443 or to export all 448 the information available.

Details for any specific job may be obtained by selecting one of the lines displayed in the information panel 443. If such details are requested, as determined at block 352 of FIG. 3, the requested details are retrieved at block 360 for display at block 364 in the form of a job-details screen for that job, as illustrated for an exemplary embodiment in FIGS. 4D-4F. The job-details screen may provide information according to a number of different parameters, identified as “Materials” 452, “History” 454, and “Piece Level” 456 in the exemplary embodiment. The specific information displayed in a details panel may depend on which of the detail types is selected by the client user. Accordingly, a check is made at block 368 of FIG. 3 to determine which detail-type selection has been made, with the relevant details being displayed respectively at blocks 372, 376, and 380 for selection of the Materials 452, History 454, and Piece Level 456 options.

FIG. 4D provides an example of a materials job-details screen 403 that may be provided to show materials information for a given job at block 372 of FIG. 3. In this instance, the details panel 458 shows information identifying specific stock used in production of documents for that job. Merely by way of illustration, several examples are provided of the types of information that may be provided. For example, a tray indicator may identify a specific holder of the supplies of stock used in the process for that job. In the examples provided in FIG. 4D, a “printer” tray may correspond to a holder of the supply going to a printer, the “carrier” may correspond to a holder of a supply of envelopes into which the documents are to be inserted for distribution, and each of the “pockets” may correspond to holders of supplies of inserts to be included with the documents when distributed. The actual stock held in the tray is identified with a “Stock Name,” and a “Stock Version” identifies the date that particular stock was approved; the “Stock Version” is shown in the example in the form YYYYMMDD. The “Stock Req'd” indicator identifies a count of the stock that the job requires; the “Stock Allocated” indicator identifies a count of the stock allocated to the job from inventory; the “Stock Used” indicator identifies a count of the stock used to complete the job; and the “Stock Waste” indicator identifies a count of wasted stock. The “Feeder Select” indicator may be used, for example, to identify whether the particular stock is to be used for all documents in the job or only for selected documents.

The job-details screen 403 shown in FIG. 4D may also include summary information 460 that identifies the total number of items of material that may be used for the given job. In addition, it may include a field 462 to allow searching according to a stock name or other parameter, and may include a field 463 to jump to a specific page where the details panel is long. As on other screens, a facility 464 may be provided for exporting some or all of the information that meets the criteria specified for that screen.

FIG. 4E provides an example of history job-details screen 404 that may be provided to show history information for a given job at block 376 of FIG. 3. In this instance, the details panel 466 provides information specifying the dates at which there was a change in status, and reflects both what the change in status was and the device at which that change in status took place. The status indicators may correspond, for example, to the possible status indicators described above in connection with FIG. 4C. Summary information 460 identifying the total number of items, a field 463 for jumping to a specific page where the details panel is long, and an export facility 464 may be included similarly to the materials job-details screen 403 shown in FIG. 4D. In addition, a search field 468 may be included to permit searching according to an entry date or other parameter.

The piece-level job-details screen 405 that may be displayed at block 380 of FIG. 3 is illustrated with FIG. 4F, and may include a details panel 470 that specifies information for each document that is comprised by a given job. Each document is identified according to its sequential position within the job (“Seq. No.”) and includes an identification of the associated account number (“Account Number”) and postal code where the document is delivered (“Zip Code”). For each document, both internal and external status conditions (respectively, “Int. Stat.” and “Ext. Stat.”) may be specified for their associated accounts, with the internal status conditions corresponding to those established by the entity managing document production, and the external status conditions corresponding to those established by the client. For example, a normal status could be indicated with a blank entry and a non-normal status indicated by one of a plurality of single-letter codes. The internal status might specify such status conditions as a delinquency, an exceeded credit limit, a combination of delinquency and exceeded credit limit, and the like. Examples of external status conditions might include notations that the customer for the account is bankrupt, the account is closed or frozen, a card associated with the account has been revoked, lost, or stolen, and the like. In addition, details regarding the document and associated materials may be identified by specifying the number of pages used to produce the document (“No. Pgs.”), the pockets from which inserts were taken to collate with the document (“Ins. Pkts.”), the pricing strategy used in processing the account (“Pric'g Str'y”), the number of convenience checks inserted with the document (“No. Checks”), and the like.

Like the other job-details screens 403 and 404, the piece-level job-details screen 405 may include summary information 460 that identifies the total number of items, a field 463 for jumping to a specific page, and an export facility 464, among other features. A search field 472 may permit searching according to such criteria as the sequence number of specific documents or other parameter.

If the operation selection identified at block 316 corresponds to a request for filtered summary, the user may be presented with information similar to that described above, but first has the opportunity to narrow the scope of what is displayed. Thus, at block 328, the user is presented with a list of different types of filter selections, as shown in the exemplary screen 406 in FIG. 4G. Any suitable interface may be used to provide the user with a list of potential filters, and the arrangement of FIG. 4G permitting separate specification of job-level and piece-level information is not required. In FIG. 4G, the choice of job-level or piece-level filters may be specified with a field 474 that includes radio buttons to make the selection and perhaps also shows a summary of the previously identified primary selection criteria 416. Depending on the choice of job-level or piece-level information, different filter selections 476 may be made available, such as indicated in FIG. 4G with check boxes, unavailable ones of which are grayed out.

Examples of the different filter selections 476 shown in FIG. 4G illustrate the types of filtering operations that may be performed, but this illustration is not intended to be exhaustive. Examples of filters that may be provided at the job level include a specification of the document type, a specification of the insert strategy, a specification of the print class to be used, a specification of the physical production area where the documents are produced, a specification of where documents are located logically within a production process, a specification of the statement type, a specification of whether the document is to be delivered domestically or not, a specification of the mailing date, and the like. Examples of filters that may be provided at the piece level include a specification of a pricing strategy, a specification of internal or external status conditions, a specification of a postal code, a specification of account numbers, and the like.

The user chooses one or more of the desired filter selections 476, which are then displayed at block 340. In the illustrated embodiment using check boxes, the user may make the choice of desired filter selections 476 by checking the corresponding boxes. An example of the filters is provided with the screen 407 shown in FIG. 4H. This example corresponds to the case where the user has selected the document-type and statement-type filters 478 and 480. Each of these is shown with a list of available selections, which may be chosen by the user highlighting the desired selection. Any alternative method of allowing the user to choose the filter selections may be used, including providing free-form fields and the like.

After the user has thus specified the filter criteria, conforming product information is retrieved by the production-monitoring computer 120 at block 348 of FIG. 3 so that the conforming summary information may be displayed at block 356. An example of a screen 408 that shows such summary information is provided in FIG. 4I. This screen 408 is similar to the job-summary screen 402 shown in FIG. 4C at block 344 of FIG. 3. In one embodiment, the details panel 484 provides information with the same headings as the production details field 440 of FIG. 4C, although this is not required. Other features of the screen 408 may also correspond to those of screen 402, including a field 444 for jumping to a specific page and an area 450 for providing summary information, although this is also not required.

After reviewing the summary information, the user may decide to examine certain jobs more closely. Accordingly, a check is made at block 352 whether the user has requested such details, such as by selecting a line in the details panel 484 that corresponds to a particular job. If so, the details may be retrieved and displayed as previously described in connection with blocks 360-380 of FIG. 3, or may be displayed in another format.

Thus, a client user is provided with a variety of different ways to retrieve and examine production information in order to monitor document production processes, depending on the specific monitoring information desired by the client user. Having described several such embodiments, it will be recognized by those of skill in the art that various other modifications, alternative constructions, and equivalents may be used without departing from the spirit of the invention. For example, the specific interface described herein is not intended to be limiting but instead to be illustrative for a particular embodiment. Accordingly, the above description should not be taken as limiting the scope of the invention, which is defined in the following claims.

What is claimed is:

1. A method for providing monitoring information for a document-production process, the method comprising:
receiving a query requesting status information for production of an identified document with a production-monitoring computer;
retrieving status data from a queriable data store in accordance with the query with the production-monitoring computer, wherein the queriable data store includes status data received periodically for a plurality of documents that includes the identified document from each of a plurality of distinct sources, each of the distinct sources being configured to provide information related to a subprocess of the document-production process; and
transmitting the retrieved status data from the production-monitoring computer as a response to the query.

2. The method recited in claim 1 wherein the identified document comprises a paper document.

3. The method recited in claim 1 wherein the identified document comprises a plastic document.

4. The method recited in claim 1 wherein the identified document comprises an electronic document.

5. The method recited in claim 1 wherein the identified document comprises a presentation instrument.

6. The method recited in claim 1 wherein the query is received from a client computer on behalf of a client managing a plurality of accounts associated with the plurality of documents.

7. The method recited in claim 6 wherein the identified document comprises an account statement for one of the plurality of accounts.

8. The method recited in claim 6 wherein the identified document comprises a card that identifies one of the plurality of accounts.

9. The method recited in claim 1 wherein the query is received from a customer computer on behalf of a customer to whom the document is to be delivered.

10. The method recited in claim 1 wherein:
the status data comprises image information; and
transmitting the retrieved status data comprises transmitting an image of the identified document.

11. A method for providing monitoring information for a document-production process, the method comprising:
periodically receiving status data for a plurality of documents from each of a plurality of distinct sources with a data-collection computer, wherein each of the sources is configured to provide information related to a subprocess of the document-production process;
storing at least a portion of the received status data in a queriable data store with the data-collection computer;
receiving a query requesting status information for at least one of the plurality of documents with a production-monitoring computer;
retrieving status data from the queriable data store in accordance with the query with the production-monitoring computer; and
transmitting the retrieved status data from the production-monitoring computer as a response to the query.

12. The method recited in claim 11 wherein at least some of the plurality of documents comprise paper documents.

13. The method recited in claim 11 wherein at least some of the plurality of documents comprise plastic documents.

14. The method recited in claim 11 wherein at least some of the plurality of documents comprise electronic documents.

15. The method recited in claim 11 wherein at least some of the plurality of documents comprise presentation instruments.

16. The method recited in claim 11 wherein the query is received from a client computer on behalf of a client managing a plurality of accounts associated with the plurality of documents.

17. The method recited in claim 16 wherein the documents comprise account statements for the accounts.

18. The method recited in claim 16 wherein the documents comprise cards that identify the accounts.

19. The method recited in claim 11 wherein the query is received from a customer computer on behalf of a customer to whom the document is to be delivered.

20. The method recited in claim 11 wherein at least one of the plurality of distinct sources comprises an information source interfaced with an external document-delivery tracking facility.

21. The method recited in claim 11 wherein at least one of the plurality of distinct sources identifies supplementary documents collated with each of the plurality of documents.

22. The method recited in claim 11 wherein the status data comprises image information for each of the documents.

23. The method recited in claim 22 wherein transmitting the retrieved status data comprises transmitting an image of the at least one of the plurality of documents from the production-monitoring computer.

24. A computer-readable storage medium having a computer-readable program embodied therein for directing operation of a production-monitoring computer including a communications system, a processor, and an interface with a queriable data store, wherein the computer-readable program includes instructions for operating the production-monitoring computer to provide monitoring information for a document-production process in accordance with the following:
receiving a query requesting status information for production of an identified document with the communications system;
retrieving status data from the queriable data store in accordance with the query with the processor, wherein the queriable data store includes status data received periodically for a plurality of documents that includes the identified document from each of a plurality of distinct sources, each of the distinct sources being configured to provide information related to a subprocess of the document-production process; and
transmitting the retrieved status data with the communications system as a response to the query.

25. The computer-readable storage medium recited in claim 24 wherein the identified document comprises a paper document.

26. The computer-readable storage medium recited in claim 24 wherein the identified document comprises a plastic document.

27. The computer-readable storage medium recited in claim 24 wherein the identified document comprises an electronic document.

28. The computer-readable storage medium recited in claim 24 wherein the identified document comprises a presentation instrument.

29. The computer-readable storage medium recited in claim 24 wherein:
the status data comprises image information; and
instructions for transmitting the retrieved status data comprise instructions for transmitting an image of the identified document.

30. A system for providing monitoring information for a document-production process, the system comprising:
a queriable data store;
a data-collection computer having a first communications system, a first processor, a first interface with the queriable data store, and a first memory coupled with the first processor, the first memory comprising a first computer-readable storage medium having a first computer-readable program embodied therein for directing operation of the data-collection computer, the first computer-readable program including:
instructions for periodically receiving status data for a plurality of documents from each of a plurality of distinct sources with the first communications system, wherein each of the sources is configured to provide information related to a subprocess of the document-production process; and
instructions for storing at least a portion of the received status data in the queriable data store with the first processor; and
a production-monitoring computer having a second communications system, a second processor, a second interface with the queriable data store, and a second memory coupled with the second processor, the second memory comprising a second computer-readable storage medium having a second computer-readable program embodied therein for directing operation of the production-monitoring computer, the second computer-readable program including:
instructions for receiving a query requesting status information for at least one of the plurality of documents with the second communications system;
instructions for retrieving status data from the queriable data store in accordance with the query with the second processor; and
instructions for transmitting the retrieved status data with the second communications system as a response to the query.

31. The system recited in claim 30 wherein at least some of the plurality of documents comprise paper documents.

32. The system recited in claim 30 wherein at least some of the plurality of documents comprise plastic documents.

33. The system recited in claim 30 wherein at least some of the plurality of documents comprise electronic documents.

34. The system recited in claim 30 wherein at least some of the plurality of documents comprise presentation instruments.

35. The system recited in claim 30 wherein:
the status data comprises image information for each of the documents; and
the instructions for transmitting the retrieved status data comprise instructions for transmitting an image of the at least one of the plurality of documents.

36. The system recited in claim 30 wherein at least one of the plurality of distinct sources comprises an information source interfaced with an external document-delivery tracking facility.
